(19) United States
(12) Patent Application Publication
(10) Pub. No.: US 2003/0011104 A1
(43) Pub. Date: Jan. 16, 2003

(54) Method for producing molded articles and a device for conducting this method

(76) Inventors: Klaus Hock, Regen (DE); Rudolf Paternoster, Rinchnach (DE); Alois Probst, Regen (DE); Joachim Schock, Lorch-Waldhausen (DE)

Correspondence Address: Edward J. Timmer, Walnut Woods Centre, 5955 W. Main Street, Kalamazoo, MI, 49009, US

(21) Appl. No.: 10/167,667

(22) Filed: Jun. 11, 2002

Related U.S. Application Data
(63) Continuation of application No. PCT/EP00/12503, filed on Dec. 11, 2000.

(30) Foreign Application Priority Data
Dec. 14, 1999 (DE) 199 60 220.4

(51) Int. Cl. B29C 39/02; B29C 39/40

(52) U.S. Cl. 264/316; 425/405.1; 425/555; 425/215

(57) ABSTRACT

The invention relates to a method for the production of molded parts having a front face and a back face made of a hardenable reaction material, whereby a casting mold consisting of several mold parts is formed, said casting mold having a configuration that remains substantially unchanged during a molding and hardening step and forming a cavity into which the reaction material is filled and hardened, whereupon the casting mold is opened and the molded part is removed from the casting mold. At least one casting mold part has a deformable surface and the cavity of the casting mold is filled with a predetermined amount of hardenable reaction material from a reservoir. The reaction material is hardened while the volume of the cavity of the casting mold is reduced by deformation of the deformable surface of the casting mold. The invention is characterized in that a deformable casting mold surface is used, which is formed by a metal layer and in that the metal layer is kept in contact with the reaction material during deformation of the deformable casting mold surface. The invention also relates to a corresponding device for implementing the method disclosed in the invention.

The invention concerns a method for producing a molded article having a visible side and a back side from a hardenable reaction compound, where a casting mold is put together from several mold parts into a configuration that essentially does not change during the casting and hardening step and that forms a cavity into which the reaction compound is filled and hardened, after which the mold is opened and the molded article is removed.

The invention additionally concerns a device for conducting such a method.

One problem that must be considered and taken into account in the manufacture of the molded articles from hardenable reaction compounds described above is that during the hardening or polymerization process a reduction of volume (shrinkage) of the polymer material occurs, which is particularly extensive when using polyacrylic- or polymethacrylic-based reaction compounds.

In order to avoid the formation of defective surfaces, which make the molded article unsellable, care must be taken at least that the still unhardened molding compound is continuously in contact with at least the visible side surface of the mold.

Various measures have previously been recommended for obtaining, in some cases, practically perfect visible side surfaces, but which still have various disadvantages from the standpoint of the overall process of producing molded articles.

On the one hand, it was recommended that the reaction compound be allowed to stand under filling pressure during the polymerization or hardening step (dwell pressure process), i.e., the connection of the cavity of the mold to the supply tank that contains the hardenable molding compound is left under filling pressure during at least a specific period of time in the polymerization process, so that in principle the volume reduction caused by shrinkage of the molding compound initially introduced into the mold can be compensated by an additional supply of fresh quantities of the reaction compound. The success of this measure is, on the one hand, dependent on the actual shape of the molded article and is frequently difficult to conduct successively, especially in the case of flat objects with low wall thickness such as kitchen sinks, since gelation of the reaction compound takes place at first during the polymerization process, which makes the additional delivery of fresh reaction compound more difficult. On top of that, this can lead to undesirable delays of the hardening operation, since the last supplied proportions of fresh reaction compound require additional time in order to harden completely. Other common related problems are an insufficient bond between subsequently injected portions of the reaction compound and the originally injected reaction compound and problems in demolding.

The edges of a flat product with low layer thickness, as is the case, for example, with kitchen sinks, present particular problems with the additional feed of material.

A proposal for an alternative solution was to use a mold whose mold parts can be forced together under pressure during the polymerization process, so that the volume of the mold cavity decreases during the polymerization process (see EP 0019867). With this the shrinkage that occurs is compensated at least at the flat parts of the mold that extend perpendicular to the clamping direction. This method requires that the two mold halves be arranged in telescoping fashion and in the edge region be sealed with an elastic seal that is deformable as the parts are pressed together. The disadvantage with this method lies in the fact that a so called casting edge also has to be cast, which stretches from the actual mold edge to the seal, which is situated at a higher level. The presence of the casting skin results in costly secondary machining, which clearly increases production costs.

The casting skin could be reduced only if the mold halves in their edge regions lie firmly against one another from the start, which however again keeps them from moving closer together during the polymerization step and thus being able to cause a reduction of the extent of volume shrinkage. For this case only the previously discussed dwell pressure method has been available up to now.

EP 0 354 017 A2 gives a method for casting polymerizable organic liquids in which a mold surface has a flexible membrane of a thermally conductive elastomer. The flexible membrane encloses a cavity, in which there circulates a liquid under pressure, which can be heated to harden the polymerizable organic liquid.

The objective of the invention is to make available a generic method that overcomes the disadvantages of the prior art, in particular to improve a method for producing a molded article as claimed at the start so that the molded articles can be obtained with minimum cost for additional processing and that the method can be carried out simply and cheaply over a long period of time.

This objective is solved by the fact that a deformable mold surface that is formed from a metal ply is used and that the metal ply is kept in contact with the reaction compound in the deformation of the deformable mold surface.

With this method the edge regions of the molds are positioned directly on one another from the start, so that the development of a casting skin can be avoided. Through the use of a deformable mold surface to reduce the volume of the mold cavity, the possibility is now created of compensating the volume loss due to the shrinkage of the polymer material during the hardening step, namely not only perpendicular to the direction of clamping of the mold, but also, if desired, three dimensionally, i.e., essentially on all sides, and the deformable mold surface essentially makes up the back surface of the mold that forms the molded article. Through different deformability different regions of the moldable mold surface regions in which higher shrinkage is expected can be more deformable than other regions in a tailored manner if necessary.

Preferably, a deformable mold surface that is elastically deformable is used, so that after the end of the hardening operation and after demolding the deformable mold returns to its original shape and thus can be reused. Alternatively, especially if there is the possibility of using cheap deformable mold surfaces, one can specify the use of plastically deformable mold surfaces which then can in each case be used just once for a casting operation. If the mold back side does not have greater importance for the appearance of the product, the mold surface could then be left on the actual molded article as a lost element.

The latter is particularly conceivable when the deformable mold surface is formed of a plastic ply.

Preferably, the deformation of the deformable mold surface is produced pneumatically or hydraulically, by injecting a liquid or gaseous pressurizing medium into the space between the mold surface and an accompanying support form.

Since the problem of shrinkage can be solved by deforming the mold surface and thus reducing the volume of the mold with the method in accordance with the invention, it becomes possible to separate the reaction compound in the mold from the supply vessel after filling the mold, i.e., the molding compound in the supply vessel does not need to continue to remain connected to the compound in the mold.

Preferably, the deformable mold surface will form the back side of the molded article, so that slight variations in the surface quality or possible deformations occurring differently over the surface can be accepted without disadvantage to the appearance of the molded article. This allows in particular the use of very thin deformable mold surfaces, and in particular the use of plastically deformable mold surfaces that can optionally remain on the molded article as a lost element.

Preferably the mold parts are assembled with edge regions lying one directly on the other, with a seal preferably being laid between the edge regions.

The lying of the edge regions on top of each other leads to the molded article having a definite edge, without having to provide a seal to prevent the escape of portions of the molding compound in every case. In contrast, it can be desirable for highly fluid components of the casting compound (especially excess monomer) to be able to escape from the mold or the mold cavity in the edge region, so that, for one thing, it is possible for this excess material to drain off, and, of course, at the same time so that it is also possible to deaerate the mold through these overlying edge regions during the filling of the mold.

In order to avoid uncontrolled escape of monomer it is also possible to add a seal between the edge regions, as noted earlier. It is preferably laid into a groove, so that the edge regions can nevertheless be in contact with each other. The groove with the positioned seal then seals the mold as a whole from the surroundings, besides sealing the superimposed edge regions.

A traditional O ring made of an elastomer that is resistant to the reaction compound can be used as sealing material. Alternatively, however, one can also use a felt material, which on the one hand keeps the deaeration function of the mold in effect, but on the other hand traps liquid portions (especially excess monomer) escaping from the cavity of the mold, and keeps the surroundings of the mold from becoming contaminated.

In many cases it is possible to eliminate all other forms of deaeration when using a felt seal. Preferably a hollow space or groove running all the way around is provided in the edge region of the mold, in the direction toward the mold cavity from the sealing groove, in which the excess monomer that flows between the superimposed edge regions can be collected. By specifying the volume of the groove (hollow space) the settling of the filler can be controlled, where again the products will largely have very little or no distortion. This groove or hollow space is preferably arranged between the circular seal and the contact line of the edge regions, i.e., the regions in which the mold parts lie directly on each other and the mold cavity is initially sealed.

In the production of molded articles that have a basin shape with a drain a connecting piece to make a flow connection to the supply vessel containing the hardenable reaction compound is arranged preferably in the region of the molded article that includes the drain.

Alternatively, or in addition, a connecting piece for making a flow connection to the supply vessel containing the hardenable casting compound can also be made at points in the molded article at which greater thickness is required, for example, at clamp lugs for securing the molded article at a work place or for other purposes, so that molding compound, which already contains considerable amounts of inorganic fillers, flowing into the mold does not lead to abrasion of the opposite mold surface as it flows into the mold.

In the regions of the molded article in which a through-hole is to be made subsequently, the mold is preferably designed so that the mold surfaces of the visible and back sides can be positioned to have a minimum spacing between them during the hardening operation.

With the mold in accordance with the invention the spacing of the mold surfaces during the filling of the mold can initially be much larger and thus enable exact filling of all of the mold regions and only upon deforming the deformable mold surface does the mold take on the desired minimum spacing in order to form the predetermined breaking line.

In this way very thin wall thicknesses arise in the regions of the molded article that are to be broken later and the separation can be produced by simply hitting the molded piece with a rubber hammer or the like. Here it is recommended in particular that the regions for the through-holes be designed so that the mold surfaces along a substantially closed line can be positioned essentially next to each other.

The invention additionally concerns a device a for carrying out the said method, where this device is characterized by the fact that it consists of a mold that can be assembled from several parts, which forms a cavity that can be filled with the reaction compound, where at least one mold part has a support form and a mold surface formed at least areawise separately from it, and that the separately formed mold surface is arranged to be deformable and/or moveable in order to reduce the volume of the cavity that is to be filled with the reaction compound.

The mold in accordance with the invention creates the possibility of producing molded articles, especially molded articles that have complicated shape such as a kitchen sink with several basins and a drain surface, with a visible side and a back side that is essentially improved in appearance, where the cost for additional machining of the molded article is considerably reduced compared to the molded articles that could be produced up to now.

This is achieved in particular by a reduction of volume or a compensation of volume during the polymerization phase through deformation of a mold surface region, for example the back side half of the mold. This mold half or its surface is made preferably of an elastic material, for example, nickel in thin sheet form, stainless steel sheet or plastic.

The deformable mold surface can either remain as a lost element (especially in the form of a cheap plastic part) on the product or can be reused and form a permanent part of the mold.

Preferably, the part of the mold that constitutes the deformable mold surface consists of a protective form of glass fiber reinforced plastic and a thin nickel sheet mold surface that is elastically deformable. The volume reduction in the cavity of the mold is achieved through a liquid pressurizing medium that is forced or injected into the intermediate base between the support form and the thin nickel sheet mold surface. Channels are preferably provided in the support form surface for uniform distribution of the pressure and regulation of the direction of flow of the pressurizing medium.

The two mold halves preferably lie flat on each other, metal to metal. The sealing surface that is thus formed should be very evenly and precisely matched in order to minimize additional machining. Nevertheless, an absolute seal cannot be achieved by laying metal on metal. For this reason a groove for holding an additional seal (for example an O ring) is provided with a spacing between it and the mold cavity. Instead of an O ring of an elastomer that is resistant to the hardenable reaction compound, it is also possible to use a felt material, where this offers the advantage of permitting deaeration of the mold during filling. In this case another mode of deaerating of the mold can possibly even be entirely omitted.

The filling points of the mold are situated either at a drain opening of the basin or at a so called clamp lug. Filling at sites that lie opposite the visible side of the mold is not recommended, since the reaction compounds that are used contain high amounts of inorganic fillers, which after only a few fillings can leave behind abrasion marks on the visible side of the surface of the sink. These will be visibly reflected on the surface of subsequently produced sinks.

The insufficient tightness of the mold halves lying metal to metal is quite useful, since this insufficient seal allows excess monomer to drain from the mold. This allows the settling of the filling to be controlled and through this the products will have very little or no distortion. In order to make operation with such molds more agreeable and to avoid fouling the environment with monomer, a circumferential hollow space is provided, preferably in the edge region of the molds, to collect excess and escaping monomer.

Finally, besides this circular hollow space, a circular sealing band can be provided, as already described.

An important advantage of the device or the method in accordance with the invention lies in the fact that compensation for shrinkage takes place not only two dimensionally, as is possible when the mold halves are moved together, but rather, three dimensionally so to speak, since through an all-sided stress on the deformable mold surface in each direction space a deformation may be achieved and in this way it is possible to check shrinkage wherever it in fact occurs during hardening. Compression or shifting of portions of the reaction compound that have already gelled in the mold is largely avoided in this way.

In the end these advantages result in a better, i.e., smoother and more uniformly made, back side of the molded article being obtained.

Moreover, the weight of the product can be maintained with considerably more precision than up to now, since one can operate with a precisely set amount of reaction compound and no additional material has to be additionally supplied to compensate shrinkage. In this way there is also the possibility of reducing the wall thicknesses of the molded article and saving the material that up to now was added for reasons of safety due to the high variations of weight and wall thickness in an individual molded article.

These and other advantages of the invention are illustrated in more detail below by means of a drawing. It shows in detail:

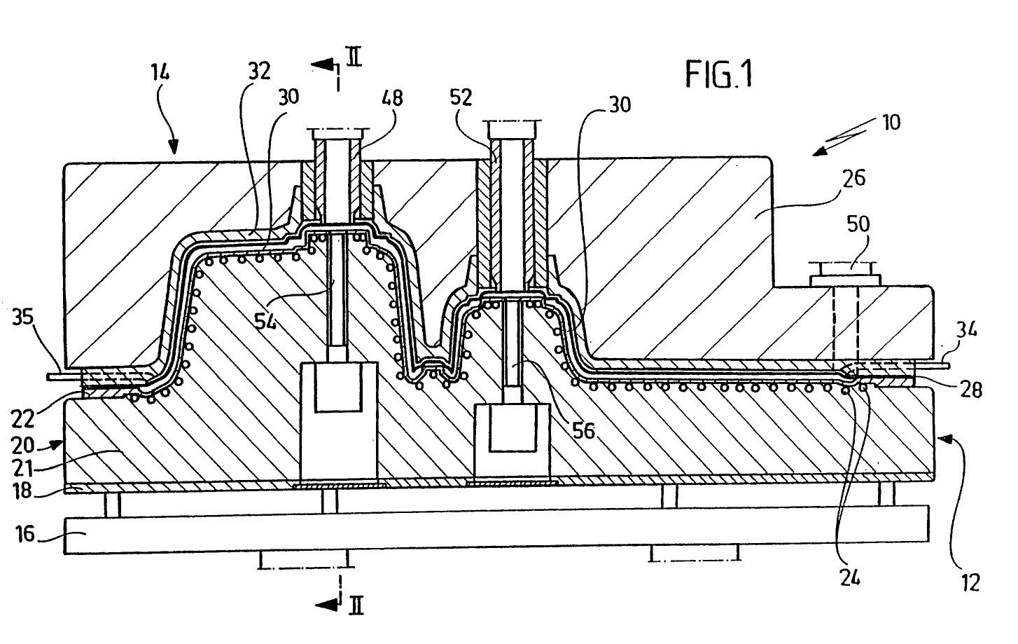

FIG. 1: a lengthwise section through a device in accordance with the invention;

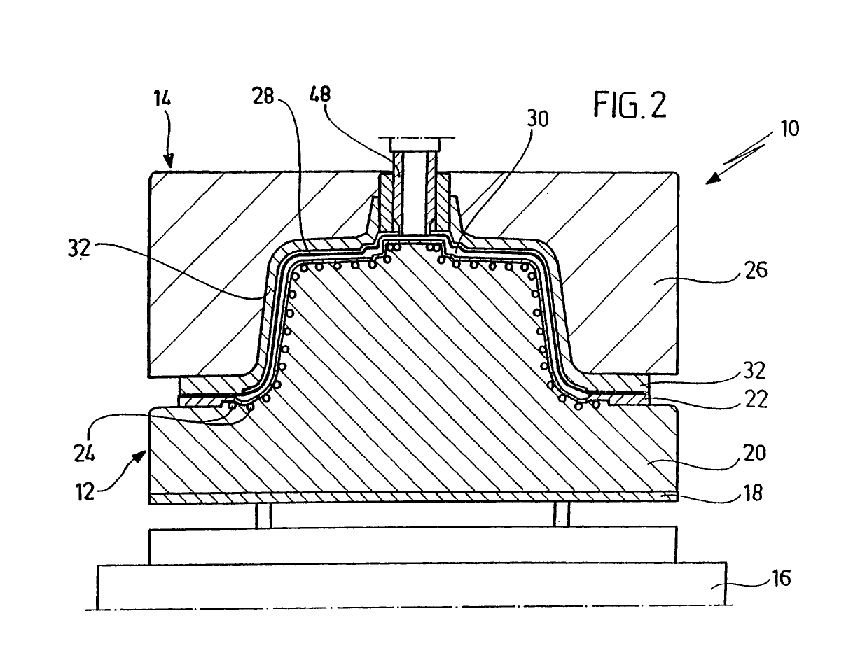

FIG. 2: a section along line II-II in FIG. 1;

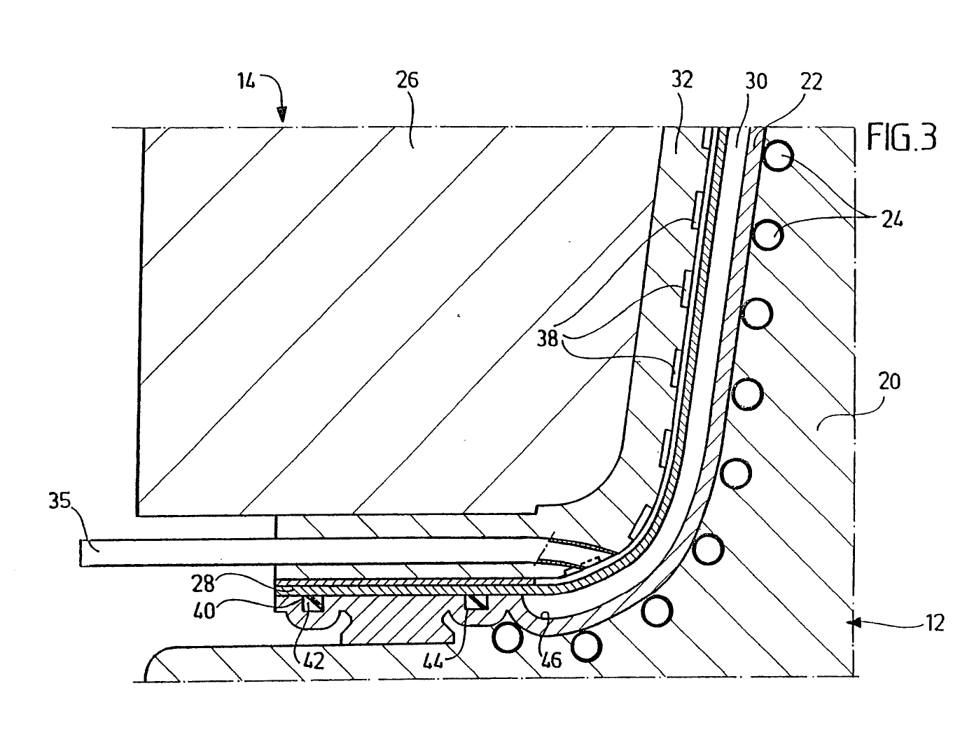

FIG. 3: a detailed view from the sectional representation of FIG. 1; and

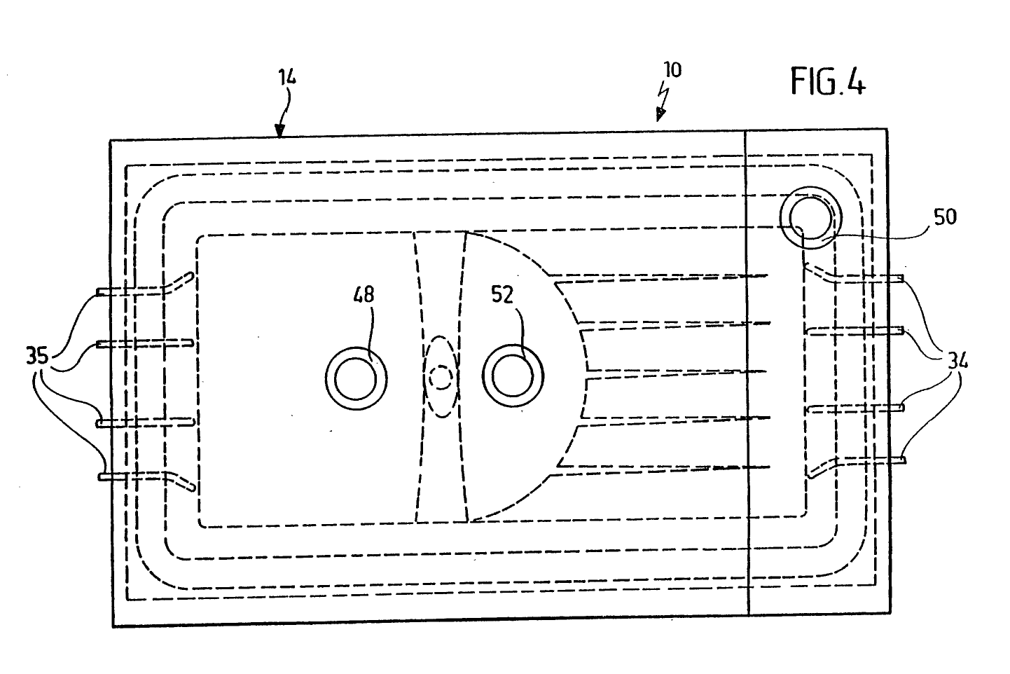

FIG. 4: a top view of the device of FIG. 1.

FIGS. 1 and 2 show a mold, designated as a unit by the reference number 10 and having a mold bottom part 12 and mold top part 14. The mold bottom part 12 is formed of a frame 16 and a plate 18 supported on this frame and includes a lower support from 20, which is designed as the positive form for producing a kitchen sink and which has on its upper side a covering with a thin nickel pan 22, which is heatable from its back side by means of a conduction system 24. The cavity remaining between plate 18 and nickel pan 22 is filled with sand in order to guarantee uniform transfer of pressure. A heating fluid is circulated through conduction system 24.

The mold top part has an upper (negative) support form 32, which carries on its surface a thin nickel pan 28. The cavity 26 remaining on the back side of support form 32 is filled with sand.

The nickel pans 22 and 28 form the surfaces of the mold cavity 30, where nickel pan 22 forms the visible side of the kitchen sink and nickel pan 28 the back side.

The support form 32 of the mold top part 14 is essentially made of glass fiber reinforced plastic.

The nickel pan 28 is held in its assembled state at a small distance from support form 32 of the mold top part 14, which distance is essentially uniform over the overall surface of nickel pan 28 or the surface of the support form 32.

The resulting cavity is connected to supply pipes 34 and 35, which are connected to a hydraulic unit (not shown).

A liquid pressurizing medium is forced through connecting pipes 34 and 34 into the intermediate space between the support form 32 and the nickel pan 28 and in this way the distance between support form 32 and nickel pan 28 can be varied, so that it is possible to vary the volume of the mold cavity 30 according to the fixed position of the mold top and bottom parts relative to each other.

FIG. 3 shows an enlarged section from FIG. 1, in which the formation of the surfaces of the parts of mold 10 can be seen in detail.

The arrangement of pipe 24 for the temperature-controlling liquid directly adjacent to nickel pan 22 of the bottom part of the mold, which thus guarantees the temperature control of the visible side surface of the mold, can clearly be seen.

The deformable mold surface that forms the back side of the molded article is formed by nickel pan 28, which implements the deformable mold surface of mold 10 in accordance with the invention.

Channels 38, with rectangular cross section, which allow essentially uniform supply of pressurizing medium to the back side of nickel pan 28 in order to enable an essentially uniform reduction of the volume 30 are recessed in support form 32. Channels 38 in the end are connected to supply pipes 34 or 35 (not shown in FIG. 3) and allow control of volume 30 during the overall polymerization process.

In the edge region the mold parts 12 and 14 lie flat on each other, as is visible in particular in FIG. 3. In the edge, which is kept relatively broad here, where flat seating of nickel pan 28 on nickel 22 occurs, there is a groove 40 provided, which accepts a sealing ring 42, which here guarantees that mold 10 will be sealed off from the environment.

Inward from seal 42, the edge region of the mold part 12 contains another groove 44, which remains unoccupied and thus forms a hollow space for monomer escaping from the mold or the mold cavity 30.

In order to design the additional machining of the finished molded article to be as simple as possible, it is of elementary importance that the edge regions of mold parts 12 and 14 are machined very accurately and are able to take up an exactly flat position with respect to each other. Because of this, at most a fish skin like progression of the polymer compound can form from edge 46 of the molded article, which can be taken care of by simple means and without great expenditures of time. In contrast to this, with the previously preferred technology, in which the upper part 14 was moved toward the under part 12 during the polymerization process, it was necessary to mill off the extension (casting edge) formed at the casting edge, which meant considerable expenditure of time and money.

Finally, FIG. 4 shows a top view of the mold 10 in accordance with the invention, in which it becomes clear that preferably several connections 34 an 35 are used in order to supply the pressurizing medium to the mold uniformly distributed over the deformable mold surface.

A filler connection 48, which is fitted with a stopcock (not shown). Deaeration of the mold can take place via the mold edge, if a gas permeable sealing material is used in groove 42. If the gas permeability is insufficient or if a gas-tight sealing material is used in groove 42, then a deaeration connection 50 becomes necessary, which is arranged in a comer region of the sink. In the filling of the mold this connection is tipped so that the comer region provided with the deaeration connection 50 forms the highest point and thus complete filling of the mold is guaranteed.

After hardening the casting compound or reaction compound the mold top part 14 is lifted from bottom part 12 and the molded article remaining there (kitchen sink) by pneumatic cylinder 52. In another step the molded article is then lifted from the mold bottom part 12 with the aid of other pneumatic cylinders 54 and 56 and then removed from mold 10 for further processing.

Because of the use of the mold in accordance with the invention, the further processing consists of only a few and non-time consuming steps. For one thing, the discharge sites of the mold are easily knocked off by hand or with a rubber hammer, since these are delimited from the remaining molded article by thin wall regions (intentional breakage sites). The edge of the sink needs only be lightly hand sanded, so that the remains of the fish skin formed during hardening are removed.

1. A method for producing a molded article having a visible side and a back side from a hardenable reaction compound, where a mold is assembled of several mold parts into a configuration that is essentially unalterable during a casting and hardening step and which forms a cavity, in which the reaction compound is filled and hardened, after which the mold is opened and the molded article is removed from the mold, in which at least one mold part has a deformable mold surface, and the cavity of the mold is filled with a predeterminable amount of hardenable reaction compound from a supply vessel, and where the reaction compound is hardened, while the volume of the cavity of the mold is reduced by deforming the deformable mold surface, which is characterized by the fact that a deformable mold surface is used that is formed of a metal ply and that the metal ply is kept in contact with the reaction compound during the deforming of the deformable mold surface.

2. A method as in claim 1, which is characterized by the fact that a nickel basin (28) is used as the metal ply.

3. A method as in claim 1 or 2, which is characterized by the fact that the deformable mold surface is deformed in at least two spatial directions including a right angle.

4. A method as in one of claims 1 to 3, which is characterized by the fact that a deformable mold surface that is elastically deformable is used.

5. A method as in one of claims 1 to 4, which is characterized by the fact that the deformation of the deformable mold surface is carried out pneumatically or hydraulically.

6. A method as in one of claims 1 to 6, which is characterized by the fact that the reaction compound is disconnected from the supply vessel after filling the mold.

7. A method as in one of claims 1 to 6, which is characterized by the fact that the deformable mold surface forms the back side of the molded article.

8. A method as in one of claims 1 to 7, which is characterized by the fact that the mold parts are assembled with edge regions lying on each other, where preferably a seal is laid between the edge regions.

9. A method as in claim 8, which is characterized by the fact that a groove for accepting the seal is provided in the edge regions.

10. A method as in claim 8 or 9, which is characterized by the fact that the edge regions lie directly on each other in the mold and that between the point of direct contact of the edge regions and the seal a hollow space is provided, in which excess amounts of the reaction compound, in particular monomer, can drain out.

11. A method as in one of claims 1 to 10, which is characterized by the fact that the mold has a basin form with a drain and that the connection with the supply vessel is made in the region of the drain.

12. Method according to one of claims 1-11, characterized in that, in areas of the molded part in which a passage opening is to be produced, the casting mold surfaces of the visible and the back side are positioned with a small spacing during the hardening process.

13. Method according to claim 12, characterized in that the casting mold surfaces are positioned essentially in contact with one another in the areas for passage openings.

14. Method according to claim 13, characterized in that the casting mold surfaces are positioned in contact with one another along a circular line passing around the passage openings.

15. Device for manufacturing molded parts having a visible and a back side from a hardenable reaction mass, the device comprising a casting mold that can be put together from several casting mold parts and forming a cavity that can be filled with the reaction mass, characterized in that at least one casting mold part comprises a support mold and a casting mold surface separated from the latter [support mold] at least in some areas and that the separately formed casting mold surface can be deformed and/or is movably arranged to reduce the volume of the cavity that can be filled with the reaction mass.

16. Device according to claim 15, characterized in that, between the separately formed casting mold surface and the support mold, a cavity of variable volume that can be charged with a hydraulic medium is formed.

17. Device according to claim 16, characterized in that the cavity of variable volume worked into the support mold comprises channels open towards the casting mold surface.

18. Device according to one of claims 15-17, characterized in that the casting mold parts have edge areas with which they are in contact with one another along a self-enclosed contact line, the edge areas preferably further comprising grooves for the accommodation of a sealing material.

19. Device according to claim 18, characterized in that the sealing material is selected from elastomer resistant to the reaction mass or a felt material.

20. Device according to claim 18 or 19, characterized in that the edge areas have a depression between the receptacle for the sealing material and the contact line.

21. Device according to one of claims 15-20, characterized in that the molded part has a basin shape with an outlet and in that the casting mold part comprising the area of the outlet has a connector in the area of the outlet for the production of a flow connection to the reservoir.

22. Device according to one of claims 15-21, characterized in that, in areas of the molded part in which a passage opening is to be produced, the casting mold surfaces of the visible and the back side can be positioned with a small spacing during the hardening process.

23. Device according to claim 22, characterized in that the casting mold surfaces can be positioned essentially in contact with one another along a self-enclosed separation line in the areas for passage openings.

24. Device according to claim 22, characterized in that the casting mold surfaces can be positioned in contact with one another along a circular line passing around the passage openings.
